(19) United States
(12) Patent Application Publication
(10) Pub. No.: US 2021/0225146 A1
(43) Pub. Date: Jul. 22, 2021

(54) IMAGE-BASED DISASTER DETECTION METHOD AND APPARATUS

(71) Applicant: Electronics and Telecommunications Research Institute, Daejeon (KR)

(72) Inventors: Sang-Won GHYME, Daejeon (KR); Hye-Jin KIM, Daejeon (KR); Seon-Ho OH, Daejeon (KR); Geon-Woo KIM, Daejeon (KR); Sang-Wook PARK, Daejeon (KR); So-Hee PARK, Daejeon (KR); Su-Wan PARK, Daejeon (KR); Kyung-Soo LIM, Daejeon (KR); Bum-Suk CHOI, Daejeon (KR); Seung-Wan HAN, Daejeon (KR); Jong-Wook HAN, Daejeon (KR)

(73) Assignee: Electronics and Telecommunications Research Institute, Daejeon (KR)

(21) Appl. No.: 17/121,287

(22) Filed: Dec. 14, 2020

(30) Foreign Application Priority Data
Jan. 22, 2020 (KR) 10-2020-0008789

(51) Int. Cl. G08B 17/12; H04N 5/232; G08B 21/10; G06K 9/62; G06K 9/00; G08B 17/00

(52) U.S. Cl. CPC G08B 17/125; H04N 5/23203; G08B 21/10; G08B 17/005; H04N 5/23299; G06K 9/00718; G06K 9/00771; G06K 9/6284

(57) ABSTRACT

Disclosed herein are a method and apparatus for detecting a disaster based on images. The apparatus includes an image capture unit for capturing video using at least one camera and controlling the camera based on a camera control signal received from the outside; a disaster detection unit for generating a disaster log based on the video captured using the camera; a disaster analysis unit for calculating a disaster occurrence probability value based on the disaster log and determining whether to enter a camera control mode based on the disaster occurrence probability value; and a disaster alert unit for warning of a disaster based on a disaster alert request signal.

### CROSS REFERENCE TO RELATED APPLICATION

This application claims the benefit of Korean Patent Application No. 10-2020-0008789, filed Jan. 22, 2020, which is hereby incorporated by reference in its entirety into this application.

### BACKGROUND OF THE INVENTION

### 1. Technical Field

The present invention relates generally to technology for detecting a disaster based on images in order to control the disaster, and more particularly to a method and system for detecting a disaster based on images, the method and system being capable of detecting the occurrence of a disaster based on Artificial Intelligence (AI) technology in response to input images captured using an imaging device, such as a CCTV, a camera installed in a drone, or the like.

### 2. Description of the Related Art

With the increasing incidence and scale of disasters, such as wildfires, floods, and the like, the scale of economic damage incurred not only by direct damage but also by indirect damage is increasing rapidly, and national and civil economic expense for recovering therefrom is also increasing. Meanwhile, due to the complex patterns of occurrence of disasters and the increasing number of unpredictable uncertainty factors, such as climate change and the like, technology capable of detecting such disasters in early stages and immediately announcing the same is required.

The global market in the field of solutions for monitoring natural disasters, detecting risks, and propagating disaster alerts is expected to grow to 123 billion dollars in 2023, compared to 93 billion dollars in 2018. In South Korea, after a wildfire on Gwanak Mountain in 2017 was detected early using CCTV, CCTV is continuously being adopted to monitor wildfires. However, because most systems are dependent on visual observation by people and because recently adopted observation using cameras installed in drones is used for rescue rather than surveillance, the unmanned monitoring field has not been actively boosted in South Korea.

Methods for detecting disasters are classified into a method using a physical sensor and a method for analyzing images captured using a camera. The method for detecting disasters using a physical sensor is widely used because various sensors therefor have been released on the market, but there is a problem in that great expense is incurred because it is necessary to install a large number of sensors in close proximity. Meanwhile, the method for detecting disasters by analyzing images has advantages in that a large area can be monitored using only a single camera and in that expenses can be reduced because observation from a remote site is possible, but has a problem of low to reliability because technology for detecting an accident from an image remains at a low level. In this technological field, methods for detecting fires from a captured image have been proposed, but the technology is still at the level at which a flame observed when an image of a fire is captured is capable of being detected only at a short distance.

With regard to this, Korean Patent No. 10-1366198 (registered on Feb. is 17, 2014), titled “image-processing system and method for automatic early detection of forest fire based on Gaussian mixture model and HSL color space analysis”, and Korean Patent No. 10-1579198 (registered on Dec. 15, 2015), titled “Forest fire management system using CCTV”, disclose methods for detecting a forest fire by separating objects from a background in an image captured by a camera using a Gaussian mixture model and by detecting the flame object of a forest fire, among objects, through HSL analysis. These methods detect only a red flame by analyzing the color space of an image. However, there are problems in that it is difficult to observe a flame from a remote site at the beginning of a forest fire and in that, when such a flame is observed from the remote site, the forest fire may already have spread to a large area.

Meanwhile, Korean Patent No. 10-1251942 (registered on Apr. 2, 2013), titled “Forest-fire-monitoring system and control method thereof”, discloses a method for analyzing a thermal image of a forest fire using a thermal camera. However, there is a problem in that when sensitivity to a thermal image of a forest fire is low, there is a high risk of malfunction, whereas when sensitivity thereto is higher, it is difficult to detect a forest fire early.

Meanwhile, for early detection of the occurrence of a wildfire from a remote site, it is necessary to detect white smoke generated at the beginning of the wildfire. Korean Patent No. 10-1353952 (registered on Jan. 15, 2014). titled “Method for detecting wildfire smoke using spatiotemporal bag-of-features of smoke and random forest”, proposes technology for detecting a smoky area from an image captured at a remote site. This method uses video, extracts feature information of a smoke image, reduces the number of malfunction errors using random forest teaming, and supports real-time operation. However, it is likely that an error will occur when a wildfire is detected using only a smoke image.

Recently, it has become possible to more accurately analyze a captured image thanks to the development of deep-learning technology. Korean Patent No. 10-1991043 (registered on Jun. 13, 2019), titled “Video summarization method”, Korean Patent No. 10-1995107 (registered on Jun. 25, 2019), titled “Method and system for artificial-intelligence-based video surveillance using deep learning”, Korean Patent Application Publication No. 10-2019-0071079 (published on Jun. 24, 2019), titled “Apparatus and method for recognizing image”, and Korean Patent Application Publication No. 10-2019-0063729 (published on Jun. 10, 2019), titled “Life protection system for responding to social disaster based on convergence technology using camera, sensor network, and directional speaker system”, propose methods configured to separate objects, such as people and the like, with high accuracy by analyzing images through training of a neural network, such as a Convolutional Neural Network (CNN), using deep-learning technology and to track these objects.

Meanwhile, methods for converting sequential data, such as voice, sound, or the like, into data in the form of an image, such as a spectrogram, and identifying objects through training of a neural network, such as a CNN, have been proposed. Korean Patent Application Publication No. 10-2018-0101057 (published on Sep. 12, 2018), titled “Method and apparatus for voice activity detection robust to noise”, discloses a method for converting an input audio signal into a spectrogram and determining whether a voice is included in the input audio signal using a model trained using a neural network. Korean Patent Application Publication No. 10-2019-0084460 (published on Jul. 17, 2019), titled “Method and system for noise-robust-sound-based respiratory disease detection”, discloses a method for converting an input sound signal into a grayscale image, extracting texture information from the grayscale image, and detecting a respiratory disease using an image classification learning model based on a convolutional neural network (CNN). These methods detect desired information in sequential data with high accuracy through training of a neural network, such as a CNN, capable of accurately extracting objects from a single image.

The above-mentioned inventions enable a disaster to be detected from a single image with high accuracy based on a CNN, but have a problem in that there is a.

high probability of malfunction. In order to reduce the incidence of malfunction, it is desirable to detect a disaster from video, rather than a single image captured using a camera. However, in the case of sequential data, such as video, it is difficult to apply a method based on a CNN, which is capable of classifying images with high accuracy, thereto.

Therefore, disaster detection technology having maximized detection performance using a learning model of a neural network, such as a CNN, based on sequential data provided from video captured using a camera is required in this technological field.

### DOCUMENTS OF RELATED ART

(Patent Document 1) Korean Patent No. 10-1366198, registered on Feb. 17, 2014 and titled “Image-processing system and method for automatic early detection of forest fire based on Gaussian mixture model and HSL color space analysis”
(Patent Document 2) Korean Patent No. 10-1579198, registered on Dec. 15, 2015 and titled “Forest fire management system using CCTV”
(Patent Document 3) Korean Patent No. 10-1251942, registered on Apr. 2, 2013 and titled “Forest-fire-monitoring system and control method thereof”
(Patent Document 4) Korean Patent No. 10-1353952, registered on Jan. 15, 2014 and titled “Method for detecting wildfire smoke using spatiotemporal bag-of-features of smoke and random forest”.

### SUMMARY OF THE INVENTION

An object of the present invention is to detect a disaster, such as a wildfire or a flood, at low cost from a remote site.

Another object of the present invention is to detect a disaster in an area within a diameter of several kilometers at low cost using CCTV or a camera installed in a drone.

A further object of the present invention is to include the dynamic change of a disaster in a single image through the process of converting sequential data in the form of video provided from a camera into a single image, thereby maximizing disaster detection performance based on a learning model of a neural network, such as a convolutional neural network (CNN).

In order to accomplish the above objects, an apparatus for detecting a disaster according to an embodiment of the present invention includes an image capture unit for capturing video using at least one camera and controlling the camera based on a camera control signal received from the outside; a disaster detection unit for generating a disaster log based on the video captured using the camera; a disaster analysis unit for calculating a disaster occurrence probability value based on the disaster log and determining whether to enter a camera control mode based on the disaster occurrence probability value; and a disaster alert unit for warning of a disaster based on a disaster alert request signal.

Here, the camera control signal is capable of including a disaster alert signal and information about a position at which it is suspected that a disaster occurs, and when the camera control signal includes the disaster alert signal and the information about the position at which it is suspected that a disaster occurs, the image capture unit may rotate the camera to be directed at the position at which it is suspected that a disaster occurs and control the lens of the camera so as to zoom in on the corresponding position.

Here, the disaster log may include information about whether a disaster occurs on a time basis and information about a place at which a disaster occurs.

Here, the disaster detection unit may detect a disaster based on an image classification method using a convolutional neural network (CNN) model trained by classifying images into general images and disaster images, and may thereby generate the disaster log.

Here, the disaster detection unit may perform disaster detection for a video section formed of n image sequences from the (t+1s)-th to (1+n*s)-th frames on a time basis in the video captured using the camera and then perform disaster detection for a video section formed of n image sequences from the (t+d+1*s)-th to (t+d+n*s)-th frames, where t may denote the start position of the video, s may denote the interval between frames selected for disaster detection, d may denote the interval between video sections selected for disaster detection, and n may denote the number of image sequences.

Here, the disaster detection unit may acquire a video section in which movement of the camera is minimized by calculating the movement of the camera using optical flow or Structure From Motion (SFM) technology and performing inverse calculation, and may thereby detect a disaster.

Here, the image capture unit may transmit the captured video to a server, and the disaster detection unit may receive image data from the server and generate the disaster log based on the image data.

Also, an apparatus for detecting a disaster according to another embodiment of the present invention may include a processor for generating a disaster log based on video captured using at least one camera, calculating a disaster occurrence probability value based on the disaster log, determining whether to enter a camera control mode based on the disaster occurrence probability value, and generating a camera control signal for controlling the camera depending on whether entry into the camera control mode is performed; and memory for storing one or more of the captured video, the camera control signal, and the disaster log.

Here, the camera control signal is capable of including a disaster alert signal and information about a position at which it is suspected that a disaster occurs, and when the camera control signal includes the disaster alert signal and the information about the position at which it is suspected that a disaster occurs, the processor may rotate the camera to be directed at the position at which it is suspected that a disaster occurs and control the lens of the camera so as to zoom in on the corresponding position.

Here, the disaster log may include information about whether a disaster occurs on a time basis and information about a place at which a disaster occurs.

Here, the processor may detect a disaster based on an image classification method using a convolutional neural network (CNN) model trained by classifying images into general images and disaster images, and may thereby generate the disaster log.

Here, the processor may perform disaster detection for a video section formed of n image sequences from the (t+1*s)-th to (t+n*s)-th frames on a time basis in the video captured using the camera and then perform disaster detection for a video section formed of n image sequences from the (t+d+1*s)-th to (t+d+n*s)-th frames, where t may denote the start position of the video, s may denote the interval between frames selected for disaster detection, d may denote the interval between video sections selected for disaster detection, and n may denote the number of image sequences.

Here, the processor may acquire a video section in which movement of the camera is minimized by calculating the movement of the camera using optical flow or Structure From Motion (SFM) technology and performing inverse calculation, and may thereby detect a disaster.

Also, a method for detecting a disaster according to an embodiment of the present invention includes capturing video using at least one camera; generating a disaster log based on the video captured using the camera; calculating a disaster occurrence probability value based on the disaster log; determining whether to enter a camera control mode based on the disaster occurrence probability value; generating a camera control signal for controlling the camera depending on whether entry into the camera control mode is performed; determining whether a disaster occurs based on the disaster occurrence probability value and generating a disaster alert request signal; and warning of the disaster based on the disaster alert request signal.

Here, when capturing the video is performed, the camera control signal is capable of including a disaster alert signal and information about a. position at which it is suspected that a disaster occurs, and when the camera control signal includes the disaster alert signal and the information about the position at which it is suspected that a disaster occurs, the camera may be rotated to be directed art the position at which it is suspected that a disaster occurs, and the lens of the camera may be controlled to zoom in on the corresponding position.

Here, the disaster log may include information about whether a disaster occurs on a time basis and information about a place at which a disaster occurs.

Here, generating the disaster log may be configured to detect a disaster based on an image classification method using a convolutional neural network (CNN) model trained by classifying images into general images and disaster images and to thereby generate the disaster log.

Here, generating the disaster log may he configured to perform disaster detection for a video section formed of n image sequences from the (t+1*s)-th to (t+n*s)-th frames on a time basis in the video captured using the camera and to then perform disaster detection for a video section formed of n image sequences from the (t+d+1*s)-th to (t+d+n*s)-th frames, where t may denote the start position of the video, s may denote the time interval between frames selected for disaster detection, d may denote the interval between video sections, and n may denote the number of image sequences.

Here, generating the disaster log may be configured to acquire a video section in which movement of the camera is minimized by calculating the movement of the camera using optical flow or Structure From Motion (SFM) technology and performing inverse calculation and to thereby generate the disaster log.

Here, capturing the video may be configured to transmit the captured video to a server, and generating the disaster log may be configured to receive image data for the captured video from the server and to thereby generate the disaster log based on the image data.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a block diagram illustrating an example of an apparatus for detecting a disaster according to an embodiment of the present invention;

FIG. 2 is a flowchart illustrating the disaster analysis procedure of a disaster analysis unit according to an embodiment of the present invention;

FIG. 3 illustrates an example in which a wildfire image is overlaid with the result of image classification for the wildfire image calculated as a probability map;

FIG. 4 illustrates an example in which a wildfire image is overlaid with a motion map;

FIGS. 5A and 5B illustrate an example of conversion of a 2D array into a 1D array and an example of conversion of N sequences formed of 1D arrays into a 2D array, respectively;

FIG. 6 is a flowchart illustrating the operation of detecting a disaster by converting the input image sequence according to an embodiment of the present invention; and

FIG. 7 is a block diagram illustrating an example of a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

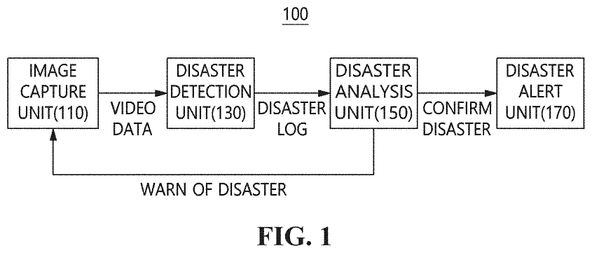

FIG. 1 is a block diagram illustrating an example of an apparatus for detecting a disaster according to an embodiment of the present invention.

Referring to FIG. 1, the apparatus for detecting a disaster according to an embodiment of the present invention includes an image capture unit 110, a disaster detection unit 130, a disaster analysis unit 150, and a disaster alert unit 170.

The image capture unit 110 captures video using at least one camera. The camera may be installed in a CCTV or a movable drone. The video captured by the image capture unit 110 may he transmitted to the disaster detection unit 130 or a server at a remote site. Meanwhile, the image capture unit 110 usually monitors a traffic accident or a disaster by sequentially changing the orientation of the camera from a short distance to a long distance according to a predetermined order. However, when it receives a disaster alert signal and a camera control signal including information about a suspected disaster spot, at which it is suspected that a disaster occurs, from the server at the remote site or the disaster analysis unit 150, the image capture unit 110 adjusts the orientation of the camera to be directed at the suspected disaster spot, zooms in and captures an image thereof, and transmits the same to the server at the remote site or the disaster detection unit 130.

The disaster detection unit 130 detects the occurrence of a disaster by analyzing video data captured by the image capture unit 110 and various kinds of feature data extracted from the video data and records the result, thereby periodically generating a disaster log. The disaster detection unit 130 may directly receive the video captured by the image capture unit 110, or may receive the same via the server.

The disaster analysis unit 150 analyzes the disaster log, thereby determining whether a disaster occurs. The disaster occurrence information detected by the disaster detection unit 130 is not accurate. Occasionally, cases in which the occurrence of a disaster is erroneously detected infrequently arise due to various reasons, such as clouds, falls, waves, birds, and the like. In this case, the disaster analysis unit 150 serves to exclude such misidentified information from the disaster log and to confirm the actual occurrence of a wildfire. To this end, the disaster analysis unit 150 calculates a disaster occurrence probability value based on the disaster log.

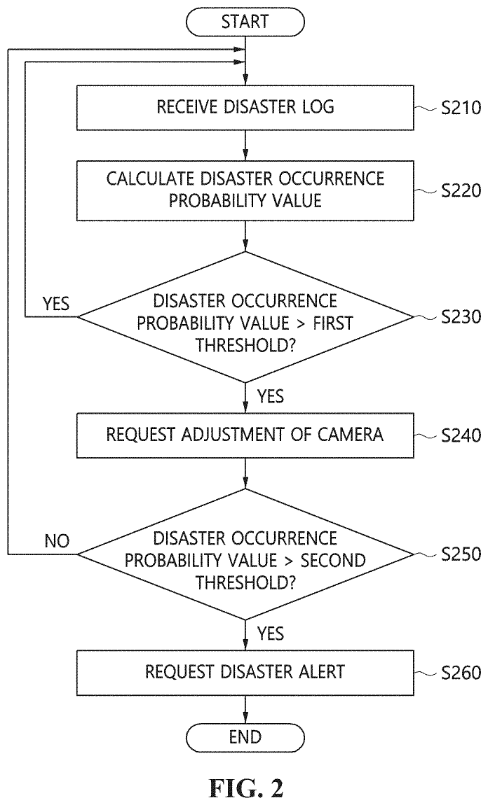

FIG. 2 is a flowchart illustrating the disaster analysis procedure of a disaster analysis unit 150 according to an embodiment of the present invention.

Referring to FIG. 2, the disaster analysis procedure of the disaster analysis unit 150 according to the present embodiment receives a disaster log from the disaster detection unit 130 at step S210.

Also, the disaster analysis unit 150 calculates a disaster occurrence probability value based on the disaster log received from the disaster detection unit 130 at step S220.

Also, the disaster analysis unit 150 determines at step S230 whether the disaster occurrence probability value is greater than a first threshold. The disaster occurrence probability value has a value close to 0 at normal times, that is, when no disaster occurs. However, when the incidence of disasters is equal to or greater than a certain frequency, the disaster occurrence probability value exceeds the first threshold.

Also, when it is determined at step S230 that the disaster occurrence probability value is greater than the first threshold, the disaster analysis unit 150 generates a camera control signal by entering a camera control mode, and requests the image capture unit 110 to adjust the camera at step S240.

The camera control signal may include a disaster alert signal and information about the position at which it is suspected that a disaster occurs. When the camera.

control signal includes the disaster alert signal and the information about the position at which it is suspected that a disaster occurs, the image capture unit 110 rotates the camera to be directed at the position at which it is suspected that a disaster occurs, and may control the lens of the camera to zoom in on the corresponding position.

Also, the disaster analysis unit 150 determines at step S250 whether the disaster occurrence probability value is greater than a second threshold. When disaster occurrence information is continuously generated at a specific spot, the disaster occurrence probability value exceeds the second threshold.

Also, when it is determined at step S250 that the disaster occurrence probability value is greater than the second threshold, the disaster analysis unit 150 confirms the occurrence of a disaster and requests the disaster alert unit 170 to issue a disaster alert at step S260. Here, the disaster analysis unit 150 may request the disaster alert unit 170 to issue a disaster alert by generating a disaster alert request signal and transmitting the same to the disaster alert unit 170.

Referring again to FIG. 1, the disaster alert unit 170 warns of the disaster based on the disaster alert request received from the disaster analysis unit 150.

Hereinafter, a method in which the disaster detection unit 130 detects a disaster from the video captured by the image capture unit 110 will be described in more detail.

The image data captured by the image capture unit 110 may be video information formed of multiple consecutive image frames.

The disaster detection unit 130 is capable of detecting a disaster from a single image frame captured by the image capture unit 110. Here, a disaster may he detected through an image classification method using a convolutional neural network (CNN) model that is trained by classifying images into general images and disaster images. According to an embodiment, a Residual Network (ResNet) may be used as a more specific CNN model, but the CNN model is not limited thereto.

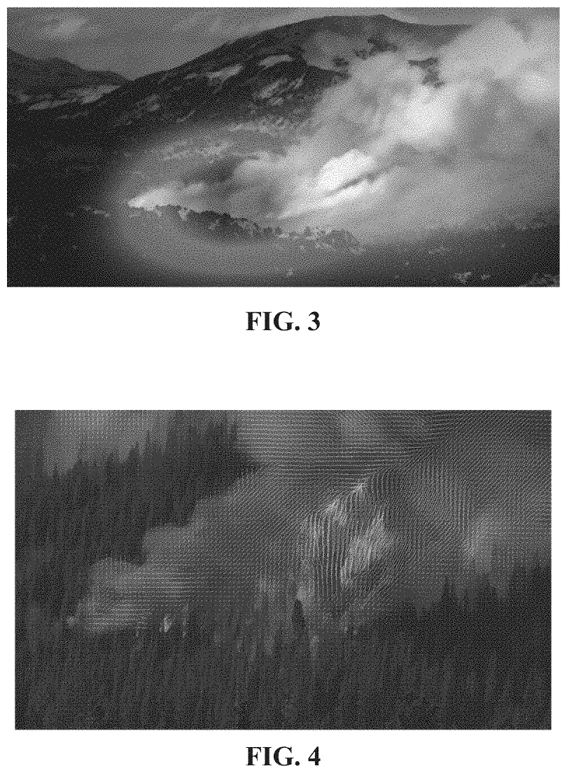

FIG. 3 illustrates an example in which a wildfire image is overlaid with the result of image classification for the wildfire image calculated as a probability map.

Referring to FIG. 3, it can be seen that the roughly estimated spot at which it is suspected that a wildfire has occurred may be checked using a single image frame based on a CNN model.

The method using classification applied to a single image may not always ensure the correct result. It is likely that an incorrect result may be reached due to various situations that are similar to and can be mistaken for a disaster. For example, in the case of a wildfire, because a captured image of the clouds in the sky (especially clouds hanging low over the mountain) looks very similar to a captured image of wildfire smoke, it is not easy to differentiate the two images from each other, and waves and waterfalls may be mistaken for white smoke due to the white foam thereof when viewed from a long distance. A single image of a snowdrift may be erroneously detected by being mistaken for white smoke. If classification is adjusted so as to enable such similar situations to also be minutely classified in a training process for image classification, the accuracy of detection of a disaster may be improved. That is, when the image classification method is changed from a method of classifying images into two types, including general images and wildfire smoke images, to a method of classifying images into various types of images, including a general image, a smoke image, a cloud image, a wave image, a waterfall image, a snow image, and the like, the accuracy of detection of a disaster may be improved.

Also, provision of video in place of a single image may be helpful to check the spread of objects related to a disaster in the video and to thereby determine whether a disaster occurs. For example, in the event of a wildfire, wildfire smoke fans out and looks like a rising 3D smoke shape. In contrast, snowdrifts are motionless, a waterfall moves downwards, and waves move so as to form a wavefront. Also, because the overall movement of clouds is linear, they spread differently from wildfire smoke.

In the case of sequential data such as video, it is difficult to apply an image-based neural network model, such as a convolutional neural network (CNN), thereto, and it is known that it is necessary to additionally use a recurrent neural network (RNN) model along therewith. However, cases in which, when a CNN has good performance, specific information is successfully detected with high accuracy by converting sequential data, such as voice or sound, into an image and applying a CNN model thereto, have been proposed. The present invention provides technology for detecting wildfire smoke using an image classification method by converting an image sequence of a certain section of transmitted video into a single image and by applying a CNN model to the single image.

The disaster detection unit 130 may perform disaster detection for a video section formed of n images (image sequence) from the (t+1*s)-th to (t+n*s)-th frames on a time basis in the video captured by the image capture unit 110, and may then perform disaster detection for a video section formed of n images (image sequence) from the (t+d+1*s)-th to (t+d+n*s)-th frames. Here, t denotes the start point of the video, s denotes the interval between the frames selected for disaster detection, d denotes the interval between the video sections selected for disaster detection, and n denotes the number of images. Here, because the target object (for example, a wildfire or flood) of a disaster progresses slowly, there may be little change between adjacent image frames in the transmitted video. Therefore, when the first image frame for forming a video section is selected, it may be necessary to select an image frame at an interval of s frames, rather than the image frame immediately following the first image frame.

The video section data formed of n consecutive images stored in the server may be difficult to directly use for detection of a disaster. There is no problem if a camera used for capturing is fixed, but because the image capture unit 110 may use a Pan-Tilt-Zoom (PTZ) CCTV camera or a camera installed in a drone, the camera may capture video while rotating, moving, or zooming in. In order to observe how a. disaster-related object (e.g., wildfire smoke, a river, or the like) progresses in each image within the video section, it is desirable that there be little difference in the position and size of the object. However, when the camera rotates, moves, or zooms in, the position of the object is not fixed in the video. In order to solve this problem, the movement of the camera used for capturing the video section is calculated by tracking the same, and inverse calculation is performed, whereby a video section in which the movement of the camera is minimized may be acquired. For example, the movement of the camera may be calculated using optical flow or Structure From Motion (SFM) technology, In the present specification, a video section in which the movement of the camera is minimized may be defined as a ‘fixed video section’, and because the edges of the images within the fixed video section are capable of being cut from the images of the original video section, the images may have a small size.

The disaster detection unit 130 may generate additional data based on the fixed video section received from the image capture unit 110 or the server, and using this additional data, the performance of disaster detection may be improved.

The disaster detection unit 130 may generate a motion map sequence by applying optical flow technology to a sequence of images in the fixed video section stored in the server. The motion map sequence indicates a sequence of motion maps. The motion map may be an image acquired by mapping a 2D motion vector field, which is the result of calculating a motion in all of the pixels between consecutive images by applying optical flow technology, onto the color space of Hue, Saturation, and Value (HSV). This motion map sequence enables (1) identifying only objects exhibiting a. distinct motion by removing a stationary background or a background moving at constant speed from a video section and (2) detecting a change in the internal structure its of each of the objects.

FIG. 4 illustrates an example in which a wildfire image is overlaid with a motion map.

Referring to FIG. 4, it can be seen that the motion vector of a background part in the image has little change, but that the motion vector inside the smoke greatly changes, whereby it may be observed that the smoke is spreading.

Referring again to FIG. 1, the disaster detection unit 130 may generate a feature map sequence by applying a convolutional neural network (CNN) for disaster image classification to a sequence of images within the video section received from the image capture unit 110 or the server. The feature map sequence indicates a sequence of feature maps. The feature map may be a value acquired by inputting images to the network of a CNN that is trained in advance using different existing datasets, such as an ImageNet.

The disaster detection unit 130 may use any one of the image sequence of the fixed video section, the motion map sequence, and the feature map sequence or a combination thereof as an input image sequence, that is, input data. This input image sequence may be represented using a 3D matrix of (N, K, M). In the 3D array, N denotes the size of the sequence, that is, the number of images, and each of the images may be represented as a 2D array of (K, M), in which case a single pixel or a pixel block (formed of P horizontal pixels and Q vertical pixels) may correspond to an element of the array.

The disaster detection unit 130 may use all of the images forming the input image sequence after enlarging or reducing the same to a certain size. According to an embodiment, when the size of each of the images forming the input image sequence is very large, it takes a lot of time to calculate disaster detection. Therefore, in order to reduce the calculation time or to reduce the amount of noise included in the image, the sizes of all of the images may be reduced to less than half.

Also, the disaster detection unit 130 may convert the 3D array of (N, K, M), which is an input image sequence, into a 2D array of (S, T), which is a single image. The 2D image converted from the 3D array may be referred to as an input flow map image. The method of convening a 3D array into a 2D array is not limited to a single method.

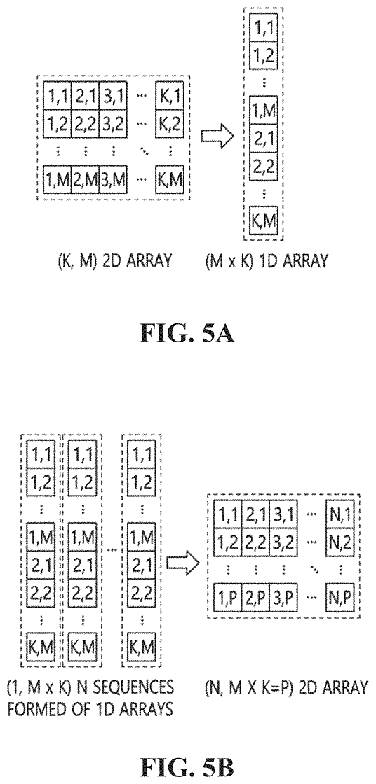

FIGS. 5A and 5B illustrate an example of image sequence conversion according to an embodiment of the present invention. FIG. 5A illustrates an example in which a 2D array of (K, M) is converted into a 1D array of (M×K), and FIG. 5B illustrates the example in which N sequences of ID arrays configured with (1, M×K) are converted into a 2D array configured with (N, M×K=P).

Referring to FIGS. 5A and 5B, when an input image sequence is configured with images having a size of (K, M), each of the images is converted into an image having a size of (1, M×K). and a sequence of N images, each having a size of (1, M×K), may be converted into an image having a size of (N, M×K). Here, when each image having a size of (K, M) is converted into an image having a size of (1, M×K), conversion may be performed using any of various methods, for example, by placing the following column below the first column or by placing the following row on the right side of the first row. Referring to FIG. 5B, the image sequence may be finally converted so as to have a size of (N, P). Here, N and P may vary depending on the input sequence.

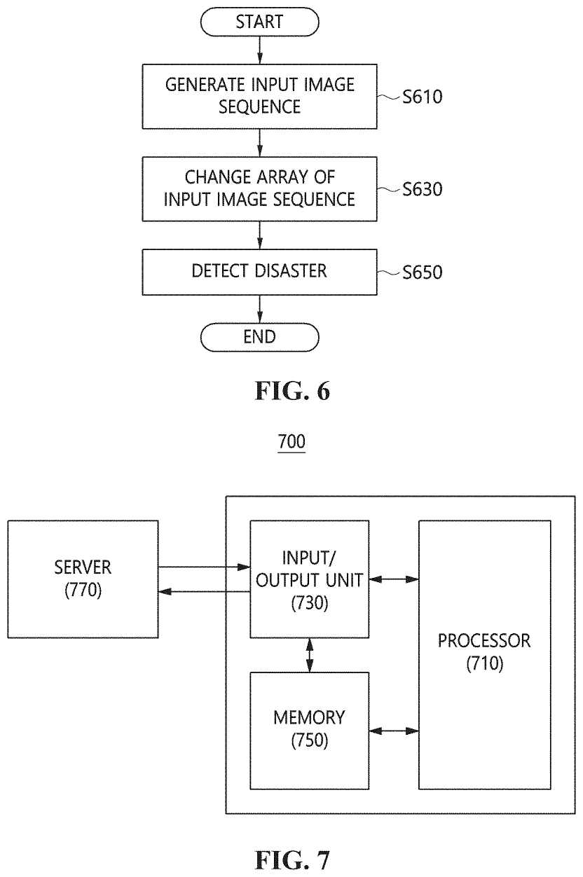

FIG. 6 is a flowchart illustrating an operation of detecting a disaster in such a way that the disaster detection unit 130 converts an input image sequence according to an embodiment of the present invention. The following operations may be performed in the disaster detection unit 130 of the apparatus for detecting a disaster.

Referring to FIG. 6, the disaster detection unit 130 generates an input image sequence at step S610.

Here, the input image sequence may be generated using any one of the image sequence of the fixed video section captured by the image capture unit 110, a motion map sequence, and a feature map sequence, or a combination thereof. For example, the input image sequence may be represented using a 3D matrix of (N, K, M). In this 3D array, N denotes the size of the sequence, that is, the number of images, and each of the images may be represented as a 2D array of (K, M).

Also, the disaster detection unit 130 converts the array of the input image sequence at step S630. For example, the disaster detection unit 130 may convert each of the images having a size of (K, M), which forms the input image sequence represented as a 3D matrix of (N, K, M), into an image having a size of (1, M×K), and may convert the sequence of N images having a size of (1, M×K) into an image having a size of (N, M×K). Here, when each of the images having a size of (K, M) is converted into an image having a size of (1, M×K), conversion may be performed using any of various methods, for example, by placing the following column below the first column or by placing the following row on the right side of the first row.

FIG. 7 is a block diagram illustrating an example of a computer system according to an embodiment of the present invention.

Referring to FIG. 7, an embodiment of the present invention may be implemented in a computer system including a computer-readable recording medium. As shown in FIG. 7, the computer system 700 includes a processor 710, an input/output unit 730, and memory 750, and the input/output unit 730 communicates with an external server 770.

The processor 710 implements the process and/or method of detecting and analyzing a disaster in the disaster detection apparatus proposed in the present specification. Specifically, the processor 710 implements all of the operations of the disaster detection apparatus described in the embodiment disclosed in the present specification and performs all of the operations of the disaster detection method according to FIGS. 2 to 6.

For example, the processor 710 may generate a disaster log based on video captured by at least one camera, calculate a disaster occurrence probability value based on the disaster log, determine whether to enter a camera control mode based on the disaster occurrence probability value, and generate a camera control signal for controlling the camera depending on whether entry into the camera control mode is performed.

Here, the camera control signal may include a disaster alert signal and information about the position at which it is suspected that a disaster occurs, and when the camera control signal includes the disaster alert signal and the information about the position at which it is suspected that a disaster occurs, the processor 710 may rotate the camera to be directed at the position at which it is suspected that a disaster occurs and control the lens of the camera to zoom in on the corresponding position.

Here, the disaster log may include information about whether a disaster occurs on a time basis and information about the place at which a disaster has occurred.

Here, the processor 710 may generate the disaster log by detecting a disaster based on an image classification method using a convolutional neural network (CNN) model that is trained by classifying images into general images and disaster images,

Here, the processor 710 may perform disaster detection for a video section formed of n images (image sequence) from the (t+1*s)-th to (t+n*s)-th frames on a time basis in the video captured by the camera, and may then perform disaster detection for a video section formed of n images (image sequence) from the (t+d+1*s)-th to (t+d+n*s)-th frames, where t denotes the start position of the video, s denotes the interval between the frames selected for disaster detection, d denotes the interval between the video sections selected for disaster detection, and n denotes the number of images.

Here, the processor 710 may acquire a video section in which the movement of the camera is minimized by calculating the movement of the camera using optical flow or Structure From Motion (SFM) technology and performing inverse calculation, and may generate the disaster log based on the video section.

The input/output unit 730 is connected with the processor 710, and transmits and/or receives information to/from the server 770. For example, the input/output unit 730 may receive image data for detecting a disaster and/or various kinds of feature data extracted from the image data from the server 770. Conversely, the input/output unit 730 may transmit the captured image to the server 770.

The memory 750 may he any of various types of volatile or nonvolatile storage media. Here, the memory 750 may store at least one of the captured image, the camera control signal, and the disaster log,

According to the present invention, a disaster may he detected with high accuracy and at a low malfunction rate by converting sequential data provided in the form of video captured by a camera in real time into a single image and by applying an image classification method using a learning model of a neural network, such as a convolutional neural network (CNN), thereto.

Also, information is compressed by compressing image sequence information to into a single image, and a method through which time-series data can be processed using only a CNN, as in a recurrent neural network, is proposed, whereby it may be possible to detect a disaster by measuring information using a small number of variables.

Also, a disaster may he detected by processing a sequence having a different length, regardless of the length of the image sequence.

As described above, the method and apparatus for detecting a disaster based on images according to the present invention are not limitedly applied to the configurations and operations of the above-described embodiments, but all or some of the embodiments may be selectively combined and configured, so the embodiments may be modified in various ways.

What is claimed is:

1. An apparatus for detecting a disaster, comprising:
an image capture unit for capturing video using at least one camera and controlling the camera based on a camera control signal received from an outside;
a disaster detection unit for generating a disaster log based on the video captured using the camera;
a disaster analysis unit for calculating a disaster occurrence probability value based on the disaster log and determining whether to enter a camera control mode based on the disaster occurrence probability value; and
a disaster alert unit for warning of a disaster based on a disaster alert request signal.

2. The apparatus of claim 1, wherein:
the camera control signal is capable of including a disaster alert signal and information about a position at which it is suspected that a disaster occurs, and
when the camera control signal includes the disaster alert signal and the information about the position at which it is suspected that a disaster occurs, the image capture unit rotates the camera to be directed at the position at which it is suspected that a disaster occurs and controls a lens of the camera so as to zoom in on the corresponding position.

3. The apparatus of claim 1, wherein the disaster log includes information about whether a disaster occurs on a time basis and information about a place at which a disaster occurs.

4. The apparatus of claim 1, wherein the disaster detection unit detects a disaster based on an image classification method using a convolutional neural network (CNN) model trained by classifying images into general images and disaster images and thereby generates the disaster log.

5. The apparatus of claim 4, wherein:
the disaster detection unit performs disaster detection for a video section formed of n images (image sequence) from (t+1*s)-th to (t+n*s)-th frames on a time basis in the video captured using the camera and then performs disaster detection for a video section formed of n images (image sequence) from (t+d+1*s)-th to (t+d+n*s)-th frames,
where t denotes a start position of the video, s denotes an interval between frames selected for disaster detection, d denotes an interval between video sections selected for disaster detection, and n denotes the number of images.

6. The apparatus of claim 1, wherein the disaster detection unit acquires a video section in which movement of the camera is minimized by calculating the movement of the camera using optical flow or Structure From Motion (SFM) technology and by performing inverse calculation, and generates the disaster log based on the video section.

7. The apparatus of claim 1, wherein:
the image capture unit transmits the captured video to a server, and
the disaster detection unit receives image data for the captured video from the server and generates the disaster log based on the image data.

8. An apparatus for detecting a disaster, comprising:
a processor for generating a disaster log based on video captured using at least one camera, calculating a disaster occurrence probability value based on the disaster log, determining whether to enter a camera control mode based on the disaster occurrence probability value, and generating a camera control signal for controlling the camera depending on whether entry into the camera control mode is performed; and
memory for storing one or more of the captured video, the camera control signal, and the disaster log.

9. The apparatus of claim 8, wherein:
the camera control signal is capable of including a disaster alert signal and information about a position at which it is suspected that a disaster occurs, and
when the camera control signal includes the disaster alert signal and the information about the position at which it is suspected that a disaster occurs, the processor rotates the camera to be directed at the position at which it is suspected that a disaster occurs and controls a lens of the camera so as to zoom in on the corresponding position.

10. The apparatus of claim 8, wherein the disaster log includes information about whether a disaster occurs on a time basis and information about a place at which a disaster occurs.

11. The apparatus of claim 8, wherein the processor detects a disaster based on an image classification method using a convolutional neural network (CNN) model trained by classifying images into general images and disaster images and thereby generates the disaster log.

12. The apparatus of claim 8, wherein:
the processor performs disaster detection for a video section formed of n images (image sequence) from (t+1*s)-th to (t+n*s)-th frames on a time basis in the video captured using the camera and then performs disaster detection for a video section formed of n images (image sequence) from (t+d+1*s)-th to (t+d+n*s)-th frames,
where t denotes a start position of the video, s denotes an interval between frames selected for disaster detection, d denotes an interval between video sections selected for disaster detection, and n denotes the number of images.

13. The apparatus of claim 8, wherein the processor acquires a video section in which movement of the camera is minimized by calculating the movement of the camera using optical flow or Structure From Motion (SFM) technology and by performing inverse calculation, and generates the disaster log based on the video section.

14. A method for detecting a disaster, comprising:
capturing video using at least one camera;
generating a disaster log based on the captured video;
calculating a disaster occurrence probability value based on the disaster log;
determining whether to enter a camera control mode based on the disaster occurrence probability value;
generating a camera control signal for controlling the camera depending on whether entry into the camera control mode is performed;
determining whether a disaster occurs based on the disaster occurrence probability value and generating a disaster alert request signal; and
warning of the disaster based on the disaster alert request signal,

15. The method of claim 14, wherein, When the camera control signal is generated, the camera control signal is capable of including a disaster alert signal and information about a position at which it is suspected that a disaster occurs, and when the camera control signal includes the disaster alert signal and the information about the position at which it is suspected that a disaster occurs, the camera is rotated to be directed at the position at which it is suspected that a disaster occurs, and a lens of the camera is controlled to zoom in on the corresponding position.

16. The method of claim 14, wherein the disaster log includes information about whether a disaster occurs on a time basis and information about a place at which a disaster occurs.

17. The method of claim 14, wherein generating the disaster log is configured to detect a disaster based on an image classification method using a convolutional neural network (CNN) model trained by classifying images into general images and disaster images and to thereby generate the disaster log.

18. The method of claim 17, wherein:
generating the disaster log is configured to perform disaster detection for a video section formed of n images (image sequence) from (t+1*s)-th to (t+n*s)-th frames on a time basis in the video captured using the camera and to then perform disaster detection for a video section formed of n images (image sequence) from (t+d+1*s)-th to (t+d+n*s)-th frames,
where t denotes a start position of the video, s denotes a time interval between frames selected for disaster detection, d denotes an interval between video sections, and n denotes the number of image.

19. The method of claim 14, wherein generating the disaster log is configured to acquire a video section in which movement of the camera is minimized by calculating the movement of the camera using optical flow or Structure From Motion (SFM) technology and by performing inverse calculation and to thereby generate the disaster log.

20. The method of claim 14, wherein:
capturing the video is configured to transmit the captured video to a server, and generating the disaster log is configured to receive image data for the captured video from the server and to thereby generate the disaster log based on the image data.
